(19) United States
(12) Patent Application Publication
(10) Pub. No.: US 2006/0047539 A1
(43) Pub. Date: Mar. 2, 2006

(54) Healthcare administration transaction method and system for the same

(76) Inventor: Paul Huang, Pasadena, CA (US)

Correspondence Address: U.P. Peter Eng;Wilson Songini Goodrich and Rosati, 650 Page Mill Road, Palo Alto, CA, 94304, US

(21) Appl. No.: 10/929,780

(22) Filed: Aug. 31, 2004

(51) Int. Cl. G06Q 40/00

(52) U.S. Cl. 705/4; 705/2

(57) ABSTRACT

A healthcare transaction method, comprising: providing a healthcare worker access to a remote central server through a user interface, and providing a payer connection to the server; receiving information from the healthcare professional through the user interface; and providing the healthcare worker automated claim assessment, claim optimization, and claim submission to the payer, based on regularly updated rules; wherein the user interface comprises a data entry device that receives data directly from the healthcare worker, and transmits it to the remote central server. A healthcare system is also disclosed.

### FIELD OF THE INVENTION

The present invention generally relates to a healthcare transaction method and system. The present invention more particularly relates to a healthcare transaction method and system that provide efficient patient administration and revenue collection for physicians and related provider entities.

### BACKGROUND OF THE INVENTION

Physicians, other ancillary service providers (e.g., pharmacies, laboratories, outpatient centers, diagnostic facilities) and payers constitute a huge, uncoordinated matrix that functions mostly on a local or regional level. The delivery of medical care to patients within this matrix has become more and more difficult and costly. Some of the factors affecting healthcare providers include: reductions in fee schedules; increasing demand for documentation of what is performed; the need to practice more defensively due to the litigious nature of the medical environment; increasing consumerism and more demanding and older, sicker patients; voluminous amounts of paperwork and procedures from the various payer organizations; higher office operating and overhead costs; significant time delays between filing claims for services provided and payment received, and even longer for initially rejected claims; increased surveillance by the government with respect to fraud and abuse issues; and more hours of work, seeing more patients for less income. These factors have increased the number of claims and cost of healthcare administration, as have the following: continuing development of new medical technology; aging of the population; extension of health care insurance coverage to more people; and increasing incidence of fraud and abuse and the increased cost of medical compliance.

The health care transaction cost factor as outlined in the June 1999 “Health Web Watch” study by Punk, Ziegel and Company exceeds $300 billion annually. The Health Web Watch study estimates that over 50% of this cost could be eliminated through the adoption of Internet based solutions for health care transactions. Given the American Medical Association's (AMA) estimate of $54 billion in claims processing cost alone, a potential savings of $27 billion or $4.22 per claim is thus attainable. Additionally, the Health Web Watch study estimates that inefficient access to clinical information costs the health care industry hundreds of millions of dollars annually in sub-optimal, under and over treatment.

The cost of claims preparation, claims examination, call center support, fraud and abuse and overhead associated with systems and personnel to execute these activities is a cost borne by payers and does not even consider the provider based costs associated with the process. The ever-increasing administrative costs of this large market are driven by the growth of health care services, inefficiencies in delivery, and low productivity that result from non-communicating legacy systems. The particular demand for large volumes of paperwork, double entry of data, and the need for human voice communication to accomplish even basic business and financial transactions has become a crisis. Many competitors lack product focus, or languish with product design problems.

There have been many attempts to control actual medical costs and their associated administrative costs. These attempts have been largely unsuccessful due to the absolute increase in the volume of care, complexity of new devices, drastic change in inputs, advancing medical technology, the aging of the population, the significant amount of fraud and abuse, and the increasingly stringent regulation by both payers and oversight agencies (including state and federal governments). As indicted in the related art, current attempts to solve this problem focus on use of the PC to electronically file claims, usually during a daily batch transmission to a claims clearing house, which then forwards the claim to the appropriate payer. After that, all disputes and issues relating to a claim and its status become the responsibility of the provider.

With specific regard to individual claim submissions, for example, payers, who generate the terms by which payment will be made, can deny or review a particular claim for a variety of reasons. Missing patient information, data entry error, double billing, unbundling of medical procedures, excessive treatments deemed not medically necessary, incorrect diagnosis (“ICDs”) codes, incomplete (e.g., unmodified) treatment (“CPT”) codes, uninsured or otherwise ineligible patients, lack of authorization or referral, wrong provider identification number, and numerous other problems exist. Any of these problems will slow processing and thus payment, or worse. Incorrect CPT codes significantly reduce reimbursement amounts—with a physician having no idea that he could have received more money. Worse yet, treatment of an ineligible (e.g., uninsured/uncovered and indigent) patient results in the involuntary imposition of a complete loss of revenues to the physician. As seen, one problem with current medical billing techniques is that they often cause physicians to be short-changed.

The aggregate of these individual losses, when coupled with the inefficiency and complexity of current business processes, results in larger systemic consequences. Current medical business transaction methods reduce revenues and disrupt effective management of physician practice groups, by individual physicians and other provider entities, including healthcare management organizations (“HMOs”), payers, physician contracting organizations (“PCOs”), independent physician associations (“IPAs”), and managed service organizations (“MSOs”).

Among such organizations, three large sources of lost revenues are the ineligibility of patients, lack of encounter and clinical data, and inflexible transmission methods. Ineligibility of patients means that a patient seen by a caregiver is not covered by insurance. Since these patients are not covered, they are considered a loss. Ineligible patients represent a considerable cost to a provider entity and the servicing physician.

A second loss leader confronted by provider entities is their lack of encounter and clinical data. Encounter and clinical data can be interpreted in many ways but it generally consists of the diagnosis and proposed treatment for a particular visit. The lack of encounter and clinical data is a significant market pain that stems from the communication schism that currently exists between physicians and their respective payers. Encounter and clinical data are vitally important to providers and payers since it enables them to determine payment to a particular physician as well as better forecast the types of care certain patient demographics require. Unfortunately, many providers still rely on manual entry of data and then submitting this via mail, fax, direct dial-up, or Internet. In many cases, when the physicians are off-site, they do not have an efficient method of capturing encounter and clinical data when delivering medical care. Often times, the physician will rely on memory, write this information on a piece of paper, or have to use a PDA or Tablet PC. Consequently, many providers and provider entities cannot effectively reduce their administrative costs since information capture relies on additional administrative resources to enter data into a system. Also, the lack of encounter data creates a literal blind spot for provider entity administrators where they are now forced to manage hundreds of physicians with insufficient information. While some provider entities currently gather encounter data today, the process is manual, employee-intensive and very costly. When a physician sees a patient, they record the diagnosis and procedure for that particular encounter. Breakdowns in communication appear when the physician or her assistant must now re-copy the same information and send it to the payer However, for those that do prepare and submit encounter data, the administrative costs are significant. The current art is vulnerable to errors and is already responsible for significant gaps in communication between the provider entity, providers, and payers.

The third loss leader stems from the lack of data capturing capabilities when the healthcare professional is delivering care outside of his or her practice. For example, healthcare professionals are often ill-equipped to adequately capture and submit encounter and clinical data when they are visiting a nursing home, hospital, or patient home since they do not have a roaming transmission method.

Regulatory hurdles further exacerbate these losses. One of the areas of resistance in the forward movement of health care Internet commerce is related to security and privacy issues. Present and future government legislation, including the Health Insurance Portability and Accountability Act (HIPAA), and a Gramm-Leach-Bliley Act relating to financial privacy, is important in setting minimum standards. HIPAA mandated that by October 2003, any entity transmitting claims or any related health care transactions electronically must use standard forms and formats. The electronic claim proposal also included new standards for other common transactions and for reporting diagnoses and procedures in the transactions. Under these proposals, payers are able to authorize services, certify referrals and coordinate benefits using one standard electronic format for each transaction.

HIPAA does not require that health care transactions be transmitted electronically, but that payer systems must be able to accept transactions in formats established by the American National Standards Institute. Protocols of the present invention allow payers to accept submission of claims, eligibility and referral information and requests, as well as benefit determinations in real-time and allow them to respond using the standard, compliant transaction set.

The effects of HIPAA are already being felt as measured by the percentage of claims filed in electronic format. In 1991, less than 20% of claims by providers and 25% of all medical claims were filed electronically. As of 1998, close to 40% of provider claims were filed electronically with all medical claims exceeding 50%. Much of the growth in filing of electronic claims is attributable to claims clearing houses rather than the payer/provider directly linking up. Almost all of these claims filed electronically were done in an Electronic Data Interchange (“EDI”) environment, rather than via the Internet.

Hence, there is a need in the current art for an efficient, accurate, and timely facilitation of electronic claim payment, preferably using the Internet. Such a system should have a significantly positive impact on the cost and operational aspects of the financial and administrative side of health care delivery for both providers and payers. Such system must also create future efficiencies based on newly created connectivity and integrated data. For example, there is a need for pre-adjudicated claims, so that claims are submitted correctly the first time. There is also a need for provider-payer interactions to be performed in as quickly as possible.

Nevertheless, the health care market sector is fragmented into hundreds of thousands of individual providers of care and payer institutions. All of these entities can be connected electronically via the Internet—the question is how to provide an efficient and mutually beneficial connection or group of connections between these entities.

One approach to providing such a solution is to use an application service provider (ASP) model that incorporates an expert system.

With regard to expert system techniques, conventional programming languages, such as FORTRAN and C, are designed and optimized for the procedural manipulation of data (such as numbers and arrays). Humans, however, often solve complex problems using very abstract, symbolic approaches which are not well suited for implementation in such conventional languages. Although abstract information can be modeled in these languages, considerable programming effort is required to transform the information to a format usable with procedural programming paradigms.

One of the results of research in the area of artificial intelligence, however, has been the development of techniques that allow the modeling of information at higher levels of abstraction. These techniques are embodied in languages or tools that allow programs to be built that closely resemble human logic in their implementation and are therefore easier to develop and maintain. These programs, which emulate human expertise in well-defined problem domains, are called expert systems. The availability of expert system tools has greatly reduced the effort and cost involved in developing an expert system.

Rules-based programming, for instance, is one of the most commonly used techniques for developing expert systems. In this programming paradigm, rules are used to represent heuristics, or “rules of thumb,” which specify a set of actions to be performed for a given situation. A rule is composed of an if portion and a then portion. The if portion of a rule is a series of patterns which specify the facts (or data) which cause the rule to be applicable. The process of matching facts to patterns is called pattern matching. The expert system tool provides a mechanism, called the rules-engine, which automatically matches facts against patterns and determines which rules are applicable. The if portion of a rule can actually be thought of as the whenever portion of a rule since pattern matching always occurs whenever changes are made to facts. The then portion of a rule is the set of actions to be executed when the rule is applicable. The actions of applicable rules are executed when the rules-engine is instructed to begin execution. The rules-engine selects a rule and then the actions of the selected rule are executed (which may affect the list of applicable rules by adding or removing facts). The rules-engine then selects another rule and executes its actions. This process continues until no applicable rules remain.

In the context of medical billing and physician practice management, then, rules-engines have been developed and employed with some degree of success. United States patent application no. 2003/0069760, for example, provides a system and method for processing and pre-adjudicating patient benefit claims that uses a rules-based process. Among other things, however, it does not provide real-time interconnection between payers and providers prior to claim submission, improve the cumbersome task of physician practice data entry, or provide payers and/or third parties a revenue-generating financial incentive to provide real-time connection to the system.

Hence, the prior art fails to provide an expert system that seamlessly interconnects providers to payers for the automated administration of all aspects of payer-related patient administration, wherever the patient and provider may be, and thus maximizes the revenues of providers, and reduces the administrative losses of payers.

### SUMMARY OF THE INVENTION

Thus, the present invention is directed to a healthcare transaction method that interconnects providers and payers for automatic and efficient rules-based claim handling, real-time eligibility determinations, and referral authorization checks.

The present invention is also directed to a healthcare transaction system that interconnects providers and payers for automatic and efficient rules-based claim handling, real-time eligibility determinations, and referral authorization checks.

One aspect of the present invention is directed to a healthcare transaction method, comprising the steps of providing a healthcare worker access to a remote central server through a user interface, and providing a payer connection to the server; receiving information from the healthcare professional through the user interface; and providing the healthcare worker automated claim assessment, claim optimization, and claim submission to the payer, based on regularly updated rules; wherein the user interface comprises a data entry device that receives data directly from the healthcare worker, and transmits it to the remote central server.

In another aspect at least one modified treatment code and an associated reimbursement value is suggested at the user interface for selection by the healthcare worker.

In yet another aspect the healthcare worker is provided a real-time interconnection between the user interface and the payer.

In still another aspect the user interface comprises a handheld device that receives data directly from the healthcare worker, and wirelessly transmits it directly to a wireless telecommunications network that is connected to the remote central server.

In yet another aspect the user interface comprises a handheld device that receives data directly from the healthcare worker, and wirelessly transmits it directly to a wireless LAN network that is connected to the remote central server.

In still another aspect the user interface comprises a transceiver that receives manually-input data directly from the healthcare worker, and wirelessly transmits it directly to a wireless network that is connected to the remote central server.

In yet another aspect the handheld device is a pen that applies ink as it receives data.

In still another aspect the handheld device is a digital recorder.

In yet another aspect the remote central server performs real-time, rules-based eligibility determinations.

In still another aspect the remote central server performs real-time rules-based referral authorizations.

In yet another aspect the user interface allows integrated access to all of a patient's books of business.

In still another aspect the remote central server provides rules-based healthcare worker management based on encounter data collected through the user interface.

In yet another aspect the remote central server provides rules-based healthcare worker monitoring based on encounter data collected through the user interface.

In still another aspect the remote central server provides rules-based advertising to the user interface.

In yet another aspect the remote central server provides rules-based selection of a pharmacy, and sends a prescription to the pharmacy.

In still another aspect the remote central server provides integrated registration, scheduling, and self-service patient check-in through an application service provider over the Internet.

Another aspect of the invention is directed to a healthcare transaction method, comprising the steps of: providing a healthcare worker access to a remote central server through at least one user interface, and providing at least one payer connection to the server; receiving information from the healthcare professional directly from the at least one user interface; and providing the healthcare professional automated claim handling and claim submission to the at least one payer, based on regularly updated rules; wherein the at least one user interface comprises a handheld device that receives data directly from the healthcare professional, and wirelessly transmits it directly to a wireless telecommunications network that is connected to the remote central server.

In yet another aspect the handheld device is a pen that applies ink as it receives data.

In still another aspect the pen transmits data to a telecommunications-to-server gateway that is in communication with the remote central server.

In yet another aspect the server is part of a rules-based application service provider expert system that integrates (1) patient scheduling and check-in; (2) automated patient eligibility checks; (3) automated rules-based, pre-adjudicated claim creation and submission; (4) automated requests for referral authorization; (5) tangible measurement of practice group financial status based on rules created based on the automatic collection of patient encounter data; and (5) creation of an additional stream of payer and third-party revenues.

Another aspect of the invention is directed to a healthcare transaction system, comprising: a workstation at a physician practice with access to a remote central server, and a payer with connection the server; and at least one workstation at the physician practice automated claim assessment, claim optimization, and claim submission to the payer, based on regularly updated rules; wherein the server receives patient information from the healthcare professional through the user interface; and wherein the user interface comprises a data entry device that receives data directly from the healthcare worker, and transmits it to the remote central server.

### BRIEF DESCRIPTION OF THE DRAWINGS

In the accompanying drawings, which form a part of the specification and are to be read in conjunction therewith, and in which like reference numerals are used to indicate like parts in the various views:

FIG. 1 is a diagram of communication connections between providers, payers, third-parties, and related functional aspects of one embodiment of a healthcare transaction method and system according to the present invention;

FIG. 2 is a diagram of some communication connections and representative individual tasks of the method and system in FIG. 1;

FIG. 3 is a flowchart of the method and system of FIG. 1;

FIG. 4 is a flowchart of several additional steps of the method and system of FIG. 1;

FIG. 5 is a diagram of communication connections and representative tasks between functional entities of a second embodiment of a healthcare transaction method and system according to the present invention;

FIG. 6 is a partial plan view of an alternate embodiment of a user interface that includes a digital pen and paper according to the present invention;

FIG. 7 is a partial side cross-sectional view of the pen of FIG. 6 and a perspective view of an associated transmission and recharging cradle according to the present invention;

FIG. 8 is a diagram of some communication connections of the system in FIG. 1, using the pen and paper of FIG. 6;

FIG. 9 is a partial flowchart of the method and system of FIG. 1, as it is used with the pen of FIG. 6;

FIG. 10 is a partial flowchart of the method and system of FIG. 1, as it is used with the pen of FIG. 6;

FIG. 11 is a flowchart of an alternate embodiment of the method and system of FIG. 1, as it is used with a digital voice recorder; and

FIG. 12 is a diagram of the method and communication connections of the system in FIG. 1, using the pen of FIG. 6 to transceive data directly to and from a remote central server through a wireless telecommunications network.

### DETAILED DESCRIPTION OF THE INVENTION

As illustrated in the accompanying drawings and discussed in detail below, one aspect of the present invention is directed to a healthcare transaction method that automates the financial transactions and administrative processes associated with patient care. This aspect provides a system that cuts losses and increases revenues of provider entities (e.g., physician contracting organizations (“PCOs”), medical groups and physician practices), cuts administrative losses of payers, and increases revenues of third-party goods and service suppliers (e.g., pharmacies and drug and device companies).

This aspect of the invention assists healthcare providers by decreasing administrative costs and maximizing revenues. It enables provider entities to automate key administrative processes quickly and efficiently, internally, as well as between themselves and their business partners. Some of the administrative processes that are managed by the system are scheduling, automatic referral authorizations, encounter management and electronic collection of encounter data for physician and patient management, eligibility determination, unified billing for all books of business, and reporting.

This system also enables provider entities to automate key reimbursement transactions quickly and efficiently, between themselves and their business partners. Thus, some of the reimbursement-related transactions that are automated are real-time discernment of patient eligibility and benefit status, the electronic collection of payment data, submission of claims, according to continually, self-updated medical management rules. As these and other administrative transactions are executed, the rules are automatically updated for future use—to formulate either ad hoc, and increasingly individualized, detailed rules based on many variables, or statistically meaningful payment tendencies (more general rules), based on fewer variables. For example, the availability of both of these rules sets maximize revenue by providing the automated generation and suggestion to a user of the most appropriate reimbursement codes.

This aspect of the invention also assists payers by decreasing their administrative costs. The ease of connectivity, and increased administrative efficiency for providers likewise reduces the administrative costs of payers, who would otherwise have to spend administrative resources to reject a larger number of faulty claims, requests regarding eligibility, and referral authorizations.

This aspect thirdly assists third-party venders by providing them a uniquely targeted marketing channel to various healthcare providers and their patients.

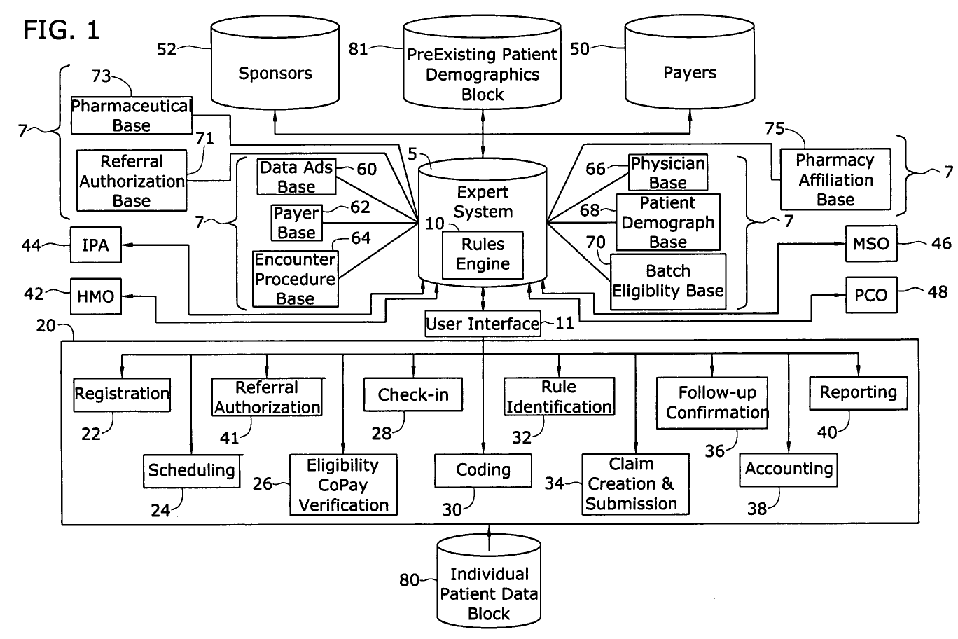

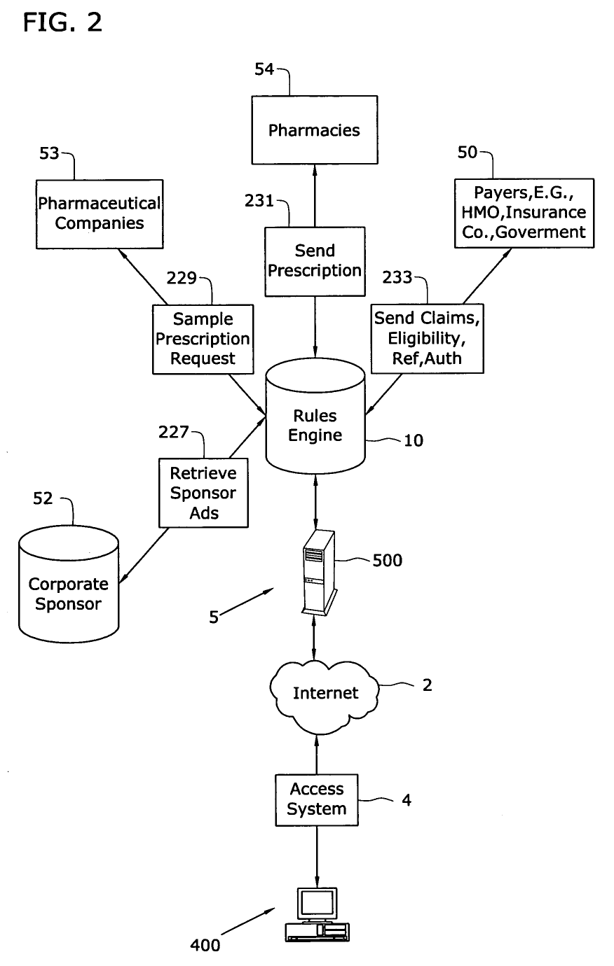

In one embodiment, this aspect of the invention is offered through the Internet using application service provider (“ASP”) technology and is governed by a rules-engine that defines the administrative processes and business transactions that take place on the system. Referring to FIG. 1, expert systems have become a powerful method for representing large bodies of knowledge for a given field of expertise and solving problems by use of this knowledge. Expert system 5, which comprises a remote centralized server 500 (shown in FIG. 2), interconnects physician practice 20 to various other provider entities (e.g., HMO 42, independent physicians association (IPA) 44, managed service organization (MSO) 46, physician contracting organization (PCO) 48, payers 50, and third-party sponsors 52. Suitable payers include, but are not limited to, insurance companies, government healthcare regulators and welfare agencies, and other policy/benefits issuing entities. Suitable third-party sponsors include any entity that has an interest in strategically advertising at any user interface 11. This typically includes pharmaceutical companies, medical device companies, and companies who wish to market products and services to medical personnel for their personal use. However, because patients (to whom some advertisements are targeted) can be any type of person, the advertising of any product or service to any intended audience is suitable for this invention.

To perform the particular functions of its role in interconnecting providers, payers, patients, and sponsors, expert system 5 comprises three parts, namely: rules-engine 10, user interface(s) 11, and set 7 of rules bases. Expert system 5 works as a dialogue conducted by user interface 11 between a user and expert system 5. The user provides information about the problem to be solved at the user interface 11 and the system then attempts to provide insights derived (or inferred) from the resulting rules bases 7. These insights are provided by rules-engine 10 after examining an appropriate rules base.

While any suitable knowledge base can be used with this invention, one embodiment of this aspect of the invention uses a rules-based solution. Suitable knowledge bases for this invention nevertheless include any knowledge base that comprises at least some type of knowledge in the form of encoding of the relevant domain of expertise (e.g., payment eligibility rules, reimbursement rules, etc . . . ) for the system. Such knowledge can be in the form of semantic nets, procedural representations, production rules, or frames. Though all three of these types of knowledge bases (as well as other types) can be used in combination or alone in accordance with this invention, one embodiment of this aspect uses only production rules for its knowledge base. Used as such these rules occur in sequences and are expressions of the form:

if <conditions> then <actions>

where if the conditions are true then the actions are executed.

Therefore, when rules from knowledge bases 7 are examined by rules-engine 10, actions are executed if the information supplied by the user satisfies the conditions in the rules.

At least two methods of inference can be used, forward and backward chaining. Forward chaining is a top-down method, which takes facts as they become available and attempts to draw conclusions (from satisfied conditions in rules) which lead to actions being executed. Backward chaining is the reverse. It is a bottom-up procedure which starts with goals (or actions) and queries the user about information that may satisfy the conditions contained in the rules. It is a verification process rather than an exploration process. An example of a backward chaining expert system is MYCIN [vMS81], and an example of a forward chaining system is Expert [WK81]. A system which uses both is Prospector [DGH79].

The particular administrative and reimbursement processes performed by a user at physician practice 20 with user interface 11 include registration 22, scheduling 24, eligibility and co-pay verification and assessment 26, referral authorization 41, check-in 28, diagnosis and treatment coding 30, rule identification 32, claim creation and submission 34, follow-up and confirmation 36, accounting 38, and practice management reporting 40 of various physician practice group or individual physician performances. Each of these processes relies on processing patient data entered at one or more user interface(s) 11 in accordance with a corresponding rules base, which includes newly entered data from individual patient data block 80 and pre-existing patient data from demographics/data block 81.

The rules bases used by expert system 5 to perform these and other tasks include, but are not limited to, advertising rules base 60, payer or medical group batch eligibility base 70, referral authorization base 71, and claim payment rules base 62, individual patient encounter rules base 64, individual physician and practice group performance rules base 66, patient demographics rules base 68, provider associated pharmacy rules base 75, and prescription rules base 73. Any rule base containing rules for the administration or control of healthcare providers is suitable for this invention, however.

Several types of rules-engines are known and any of a variety thereof may be used to carry out the present invention. Rules-engine 10 may be implemented as hardware, software, or combinations thereof. Suitable examples of rules-engines include, but are not limited to, those described in U.S. Pat. No. 5,263,127 to Barabash et al. (Method for fast rule execution of expert systems); U.S. Pat. No. 5,720,009 to Kirk et al. (Method of rule execution in an expert system using equivalence classes to group database objects); U.S. Pat. No. 5,642,471 to Paillet (Production rule filter mechanism and inference engine for expert system); U.S. Pat. No. 5,664,062 to Kim (High performance max-min circuit for a fuzzy inference engine), which are hereby incorporated by reference in their entities. High-speed rules-engines are preferred so that newly entered data more quickly informs the system's continually updated rules. One embodiment uses the Jess rules-engine, which is updated weekly, or alternately, monthly. Various rules bases are automatically or manually updated upon claim rejection depending on the specific payer involved. Such updates are overridden if the claims rejection for a particular payer is made in error by the payer.

As with knowledge bases 7 and patient information in blocks 80 and 81, rules-engine 10 may be a separate block from the knowledge bases 7 and patient information 80 and 81, or may be combined together in a common program or routine.

In one embodiment, rules-engine 10 uses the Rete algorithm to process rules, a very efficient mechanism for solving the difficult many-to-many matching problem (see, e.g., “Rete: A Fast Algorithm for the Many Pattern/Many Object Pattern Match Problem”, Charles L. Forgy, Artificial Intelligence 19(1982), 17-37.)

In one embodiment, user interface 11 comprises an ASP model, which requires no pre-loaded software at the user's physical location. It comprises a work station 400 (shown in FIG. 2) having data entry keyboard and computer monitor. However, other suitable user interfaces can include, but are not limited to, handheld devices such as PDAs, tablet PCs, digital pens, digital handheld recorders, and other data entry devices that are connected to the Internet (as described further below). Moreover, the functioning of suitable user interfaces can include connection through several methods including, but not limited to, wireless LAN systems and wireless telecommunication systems (WAN) that electronically transceive, as also described below. Thus, wireless user interfaces suitable for use in the present invention include any and all wireless systems, of any frequency. However, user interfaces that can be employed with the present invention also include any device or system (used in whole, in part, or in any combination thereof), suitable for receiving and/or transmitting digital, electronic data from a healthcare professional (e.g., wireless phones, Bluetooth™-equipped digital pens, Blackberry™, and Sidekick™ devices). User interfaces are interchangeable with other types of user interfaces or combinations of user interface types at various stages, or functions, of expert system 5 usage. The appropriate user interface depends on several variables such as the identity and function of the user, as well as his or her accessibility to various types of user interfaces.

Referring to FIGS. 1 and 2, in one embodiment expert system 5 electronically provides healthcare provider's personal computer 400 access 4 through the Internet 2 to rules-engine 10, which applies regularly-updated payer 50's claim policy rules 62, 70, 71, provider associated pharmacy 54 rules 75, prescription rules 73, and demographically specific advertisement rules 60. Rules-engine 10 accordingly (1) sends referral authorizations, eligibility checks and claims 233 to payers 50 (e.g., HMOs, insurance companies, and government agencies); (2) sends prescription requests 231 to pharmacies 54; (3) requests sample prescriptions 229 from pharmaceutical companies 53; and (4) retrieves sponsor advertisements 227 from third-party corporate sponsors 52, among other tasks.

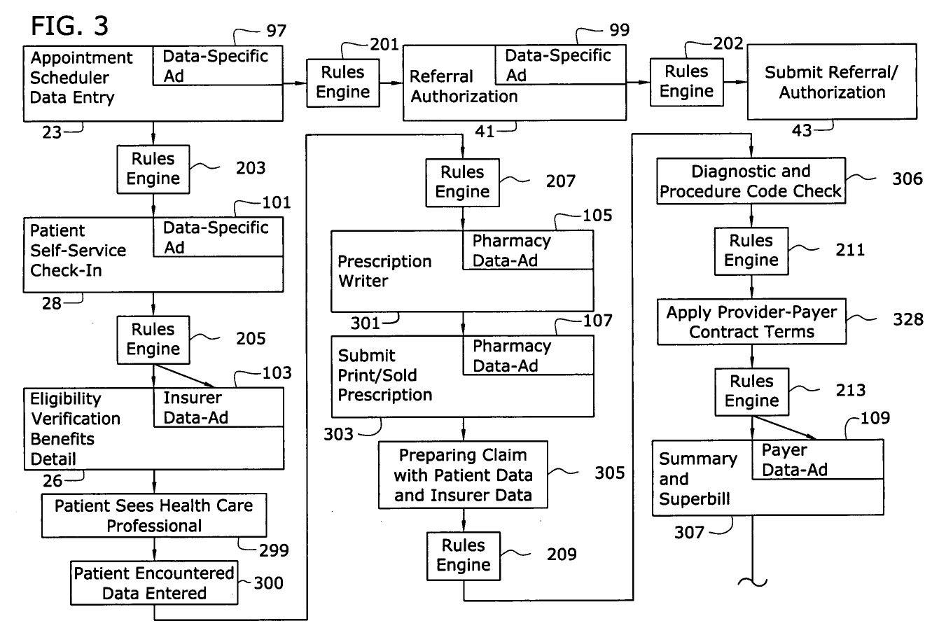

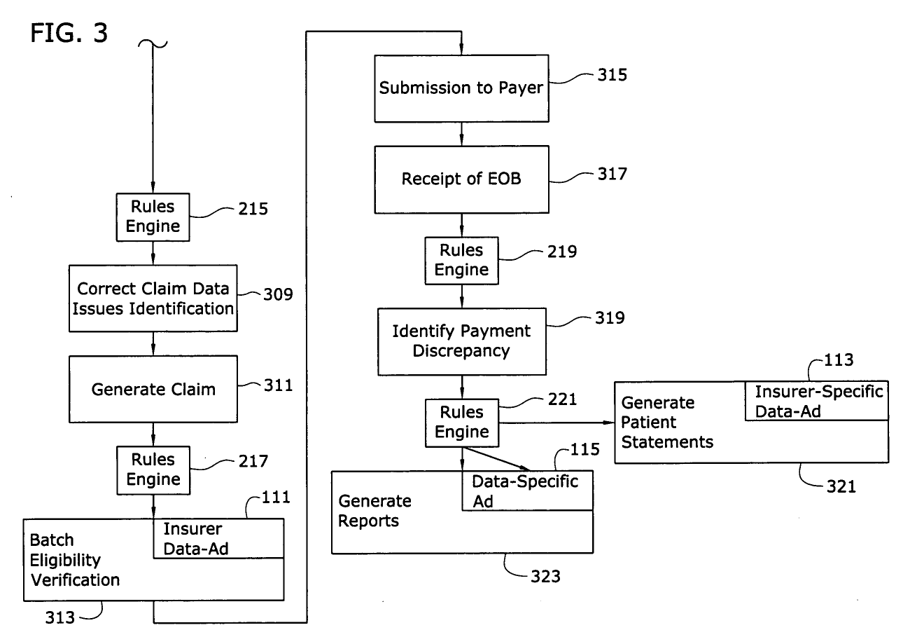

Expert system 5 thus automates and refines many of the administrative and financial business processes that are central to operating a doctor's office or larger medical group optimally. Referring to FIGS. 1 and 3, a user, such as a provider's administrative staff person, enters 23 a patient's name and other information into appointment scheduler 24. Rules-engine 10 causes user interface 11 to display advertisement 97, which is demographically-specific according to previously stored data regarding the patient and/or provider in question. In fact, at each stage of use, the user(s) receives such advertisements targeted according to various demographics categories including, but not limited to, practice area specialty, personal information, diagnosis, and treatment. More than one of these advertisements can be shown at any stage, and the time and placement of subject-specific and demographic-specific advertisements are interchangeable. Advertising content is continuously updated, depending on the advertiser, and the advertising message links to more in depth product information featuring video, audio, flash media and JAVA script.

Rules-engine 10 also causes user interface 11 to reject the attempt 201 to schedule the patient—to prevent such patient from seeing the physician for whom the user performs scheduling. This rejection is based on rules from any rules base, e.g., including practice area specialty treatment eligibility and payment eligibility rules in base 70 or another of myriad policy rules that govern patient scheduling.

Either as an automatic response to this rejection, or in response to the user's request to refer the patient to an inside-network specialist, rules-engine 10 performs a preliminary referral authorization 41 according to provider network rules and/or payer rules as appropriate, and causes interface 11 to display either a preliminary authorization or a denial with prompting to re-enter corrected data. Rules-engine 10 causes user interface 11 to display advertisement 99, which is demographically-specific according to referral data or previously stored data regarding the patient and/or provider in question. Once the preliminary referral is accepted as matching appropriate rules, rules-engine 10 automatically submits the referral 202 for further official authorization 43 to the appropriate provider entity or payer, as needed. This automates the approval of routine referrals while red flagging the procedures that need further attention.

In an alternate embodiment where the patient is accepted for scheduling to see the physician for whom the user schedules (no referral needed), expert system 5 displays markers within scheduling module 24 next to each patient's appointment. These markers indicate whether a patient is eligible, ineligible, needs their eligibility checked, or if the patient needs to have his profile updated. This connectivity is a real-time connection that allows for the availability of accurate and up-to-date information about payer eligibility rules and benefit payment tendencies. Once the patient checks himself in 28 using a user interface device such as a touch screen display, rules-engine 10 causes user interface 11 to display advertisement 101, which is demographically-specific according to check-in data or previously stored data regarding the patient and/or provider in question. Rules-engine 10 also determines benefits eligibility 205 according to payer and provider rules and, if preliminarily eligible for treatment, automatically and electronically verifies eligibility 26 in real-time, with the appropriate payer and/or provider authority. Rules-engine 10 causes user interface 11 to display advertisement 103, which is demographically-specific according to check-in data or previously stored data regarding the patient and/or provider in question. If ineligible, the patient has further opportunities to correct patient data to confirm ineligibility. As with any preliminary rejection, expert system 5 automatically updates rules base 70 by adding the unforeseen, changed, or conflicting rule that caused the discrepancy between the projected outcome, and the actual decision by the payer.

After visiting 299 the physician, prescriptions are advertised and suggested, selected and submitted. A prescription, diagnosis, and treatment are entered 300 into user interface 11. Rules-engine 10 accepts or rejects 207 the prescription according to provider 66, 68, 64, payer rules 62, or pharmaceutical company rules 73. If rejected, expert system 5 automatically updates the appropriate rules base by adding the unforeseen, changed, or conflicting rule that caused the discrepancy between the projected outcome, and the actual decision by the payer. If accepted, several prescription options are offered with or without pricing options, including patient coverage amounts, and a change in prescription is allowed 301. In any case, rules-engine 10 causes user interface 11 to display pharmacy or pharmaceutical advertisement 105, which is demographically-specific according to check-in, diagnosis, and/or prescription data, or previously stored data regarding the patient and/or provider in question. After the prescription is selected, it is submitted to the payer and either printed for the patient, or automatically send to a nearby, or otherwise preferred, pharmacy 303. In one embodiment, a provider-affiliated or otherwise sponsoring pharmacy receives the prescription.

Rules-engine 10 also prepares and displays a preliminary claim using patient and payer data 305. In accordance with this data, information from payer rules base 62 is provided to rules-engine 10, which generates a listing of available treatments and the corresponding advisory information from the information provided by payer rules base 62. This includes the automated display of at least one suggested CPT code with modifier(s) and associated reimbursement amount(s) 209, so that the most appropriate treatment code can be selected by the user, which thereby avoids a lower reimbursement level(s) than the physician otherwise deserves. Thus, when a particular ICD and CPT is selected, rule engine 10 selects related ICD and CPT codes that may be appropriate and displays them to the user for his or her selection. In one embodiment, this connectivity is a real-time connection that allows for the availability of accurate and up-to-date information about payer rules and payment tendencies. Once appropriate CPT code(s) is/are selected 306 by the user, rules engine 10 checks 211 for accurate data entry of patient information codes and modifiers. It applies 328 additional provider and payer rules, including corresponding advisory information, from rules base 62 and generates 307 both a summary and more particularized invoice (i.e., a super bill). Rules-engine 10 also causes user interface 11 to display payer data advertisement 109, which is demographically-specific according to check-in, diagnosis, and/or prescription data, or previously stored data regarding the patient and/or provider in question. Rules-engine 10 checks for data entry errors, incorrect data formats, etc.

Correction of claim data issues such as birth dates, subscriber IDs, payers, SS#s, provider IDs, etc. are identified 309 by rules-engine 10, which then generates 311 a clean, preliminarily acceptable claim once the user makes the suggested corrections.

Rules-engine 10 then applies 217 rules from batch eligibility rules base 70 to the patient's data 80 and 81 and causes user interface 11 to display 313 batch eligibility verification especially designed for PCOs and medical groups to ensure that their physicians are aware of the eligibility status of patients as well as the extent of their respective benefits before they leave the healthcare facility. This increases the prompt and full payment of out-of-pocket costs, even when payers are not available for eligibility verification, such as during non-business hours. Thus, one embodiment of the present invention provides real-time connection to a repository of patient-specific payer eligibility rules that is regularly updated, and is available at all times. In several alternate embodiments, these rules 70 and/or patient data 80 are alternately updated every quarter, month, week, or day. Any rules base can be updated as such, also.

Rules-engine 10 also causes user interface 11 to display payer data advertisement 111, which is demographically-specific according to check-in, diagnosis, and/or prescription data, or previously stored data regarding the patient and/or provider in question.

The superbill for reimbursement is electronically submitted 315 to at least one payer, who in turns sends an electronic explanation of benefits (EOB) 317 to the user. Rules-engine 10 applies payer rules 62, to the patient's data 80 and 81 to identify 219 and report 319 to expert system 5's administrator any discrepancy in the earlier-projected claim that was sent. Expert system 5 then automatically updates 221 the appropriate rules base or alerts expert system 5 administrator of possible rules or other issues to be manually resolved. Finally, rules-engine 10 generates internal provider report 323 to the user on a case-by case basis along with data-specific advertisement(s) 115. Rules-engine 10 likewise generates patient invoice statement 321, including any balance due, and health insurance advertisements 113 for marketing to patients or providers.

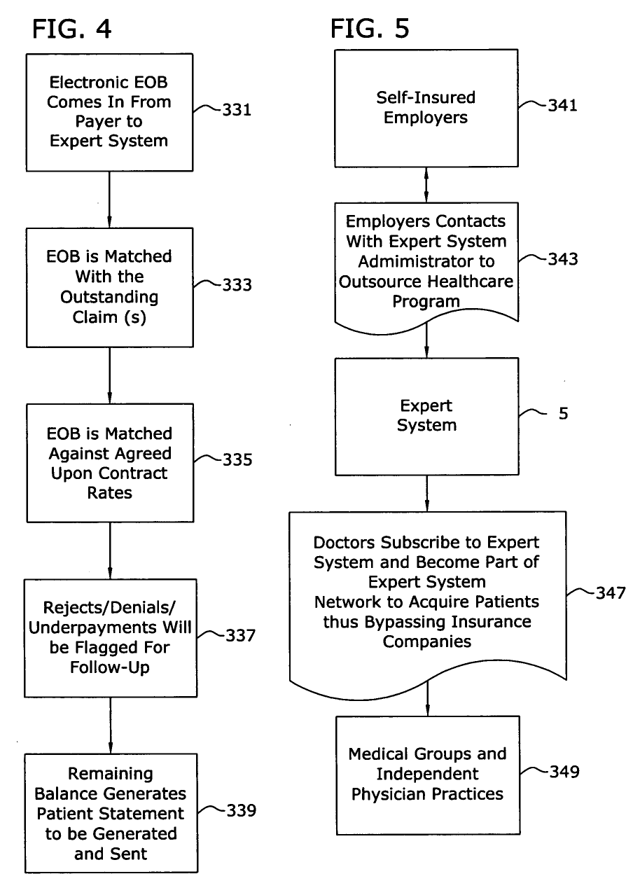

Referring FIG. 4, in one embodiment electronic EOB is received 331 by expert system 5 from a payer. Electronic EOB is matched is then matched 333 with the outstanding claim or claim(s). EOB is matched against agreed upon contract rates 335 from rules base 62. Rejections, denials and underpayments are individually flagged and displayed 337 at user interface 11 for follow-up by user or expert system 5 administrator. Expert system 5 generates patient statement with balance due and sends to user interface 339 for forwarding to patient by mail, by e-mail, or by hand immediately after the patient visit. Expert system 5 automatically updates rules base 62 by adding the unforeseen, changed, or conflicting rule that caused the discrepancy between the projected outcome, and the actual decision by the payer.

Referring to FIG. 5, in another embodiment self-insured employer 341 is the payer, who contracts 343 with expert system 5 administrator to handle self-insured employer 341's healthcare program, and is electronically connected to expert system 5 for this purpose. Expert system 5 is electronically connected to physician network 349, comprising medical groups and independent physician practices made up of physicians who have subscribed to expert system network 347. This allows physicians the ability to acquire new patients, not covered by insurance companies per se.

Thus, this aspect of the invention delivers a new level of efficiency, automation and communication among provider entities, and between provider entities and payers that allows many provider entities to reduce administrative staff, or alternately, scale up their membership without hiring additional administrative staff.

This aspect of the invention further enhances the management of physician groups and individual physician practices by enabling managers to determine the effectiveness of a particular physician within their network, as well as to forecast the types of care a certain patient will require according to that patient's demographics. Referring again to FIG. 1, using physician rules base 66, managers can regulate their physicians on a physician-by-physician basis when applied to a particular patient's newly entered data 80 or patient demographic data from block 81. Using the self-updating diagnosis and treatment encounter rules base 64, managers can predict and implement treatments that are more effective, especially where multiple treatments are in order, when applied to new data entry and stored data information in patient demographics blocks 80 and 81. Expert system 5 also generates weekly, monthly, quarterly, and monthly statements regarding cumulative effectiveness of individual physicians or practice segments for provider entity management review.

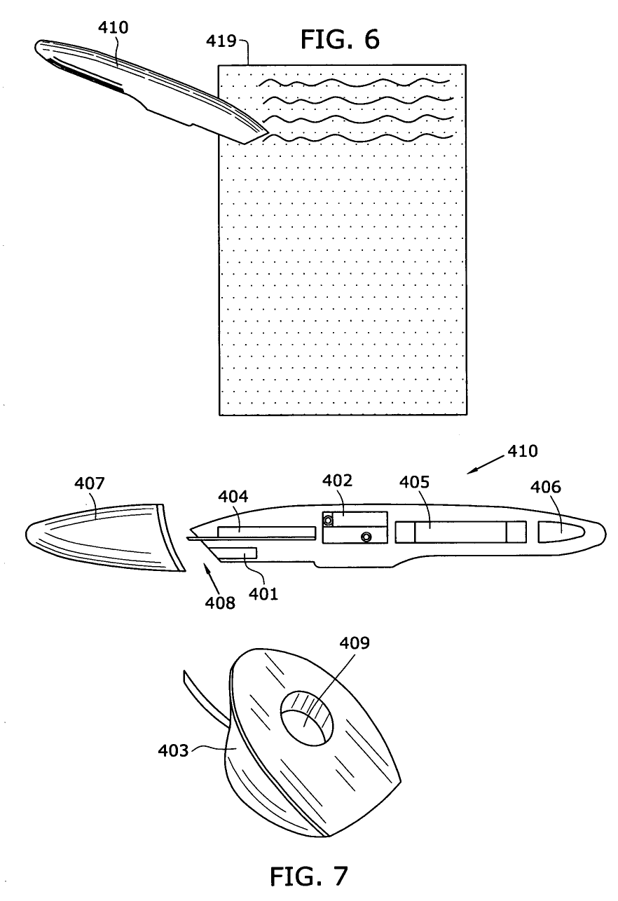

Referring to FIG. 6, in an alternate embodiment user interface 11 comprises “digital” paper 419 and digital pen 410 that receives data entry from the user as the user simultaneously writes ink onto paper 419.

Referring to FIG. 7, pen 410 includes optical sensor 401 that digitally captures whatever the user writes. Processor 402 digitizes the optical signal into data that is transferred to dual function, recharge and data transfer USB cradle 403, which transfers data to a personal computer. Pen 410 is recharged and uploads data when data transmission port 408 is placed into connection port 409 on cradle 403. Replaceable ink cartridge 404 provides ink for writing that permanently adheres to paper 419, just as a normal pen does. Memory chip 405 stores up to 40 pages 419 of data, and battery 406 lasts for the collection of up to 25 pages of data between recharges at cradle 403. Cap 407 turns pen 410 off when placed on pen 410, and on when taken off pen 410.

One suitable set of paper, pen and electronic recording and communication of data is the “iScribe Digital Forms and the Logitech® io™ Digital Pen” available from Logitech, Inc. and respectively described in, inter alia, U.S. Pat. Nos. 6,689,966, 6,719,470, and 6,698,660, which are hereby incorporated by reference in their entireties. Any pen or pen and cradle combination that can be used to collect and directly transmit data to and/or from a personal computer or other device that can be connected to a remote central server is suitable for use in this embodiment, however. Suitable connection examples include, but are not limited to, wired connection to a user's office server connected via the Internet to expert system 5, and wireless connection wherein cradle 403 is connected to PC 400, and thus the Internet and expert system central server 500, via a wireless LAN. Also suitable is a digital pen wherein a wireless LAN connects of the digital pen directly to PC 400, without the need of communication function of a separate cradle.

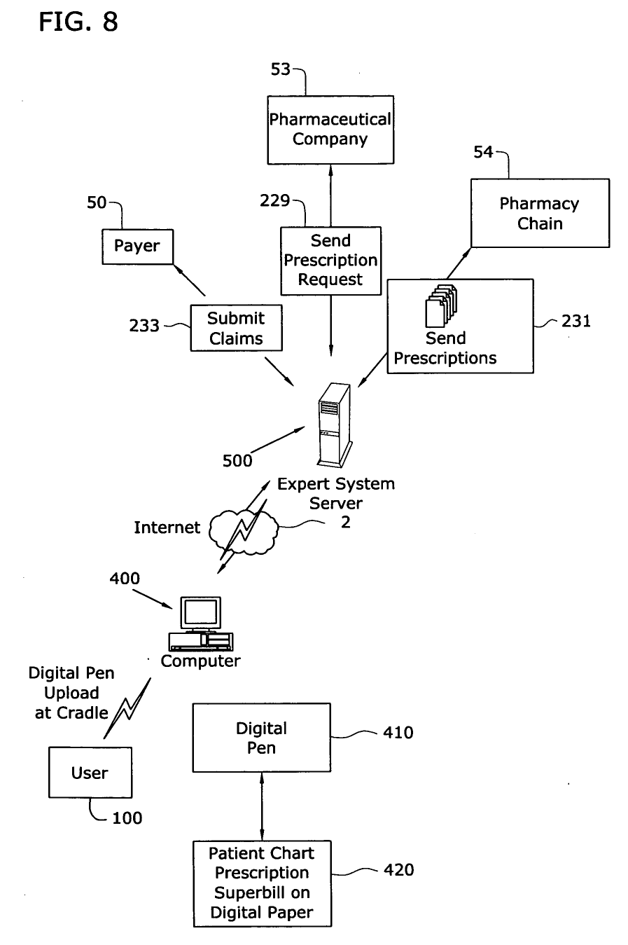

Referring to FIG. 8, thus, user 100 writes on pre-printed digital form 420, which includes print out forms of a patient's chart, prescription and total invoice. Digital pen 410 scans as it writes and coverts optical signal into data that are uploaded into 400, which is connected to payer 50, pharmaceutical company 53 and pharmacy 54 through expert system remote central server 500.

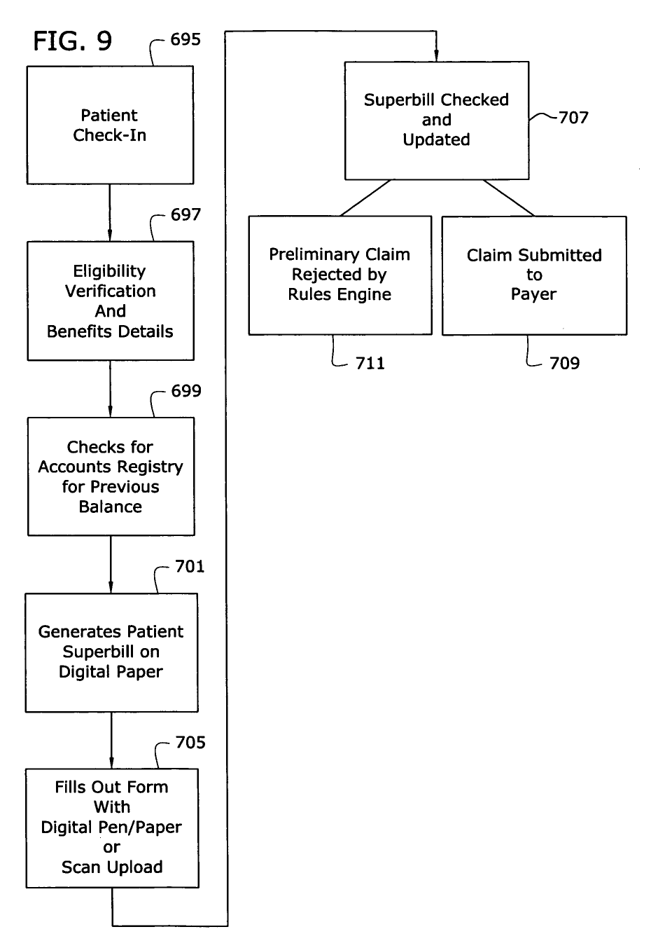

Referring to FIG. 9, after check-in 695 and eligibility check 697, which includes retrieval of benefits detail, the account registry is checked 699 for a previous balance by rules-engine 10. Patient eligibility status and benefits detail are generated 701 by incorporating these into a soft version of patient chart, prescription and total invoice form, which are stored and printed onto digital paper form or forms 420. The user fills out form 420, as it uploads 705 into user's PC where it is checked and validated 707, and a pre-processed claim is sent 709 to a payer. When the claim is preliminarily rejected, an e-mail message is sent to the user to request correction 711.

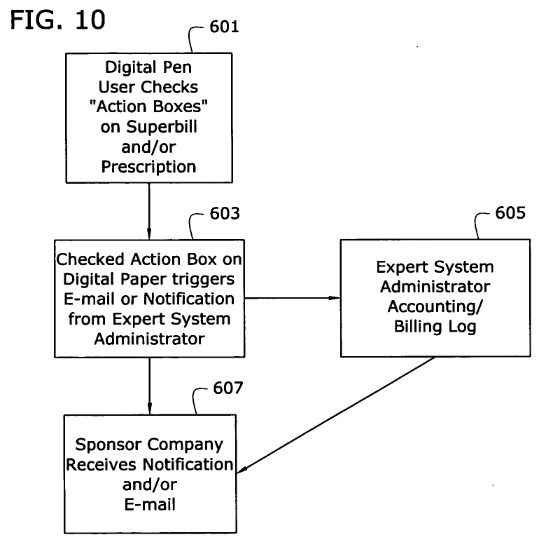

Referring to FIG. 10, in one embodiment a user checks 601 action boxes on digital paper form 420. Checked box on digital form 420 is transmitted to pen interface and transmitted to expert system 5's server. In response, expert system 5 sends 603 an e-mail message or notification to a user. For example, the action box “Send Samples” on digital prescription paper 420 is checked and digital pen 410 “reads” the action box, transmits data to expert system 5, which sends an e-mail or other notification to pharmaceutical company 53 requesting samples.

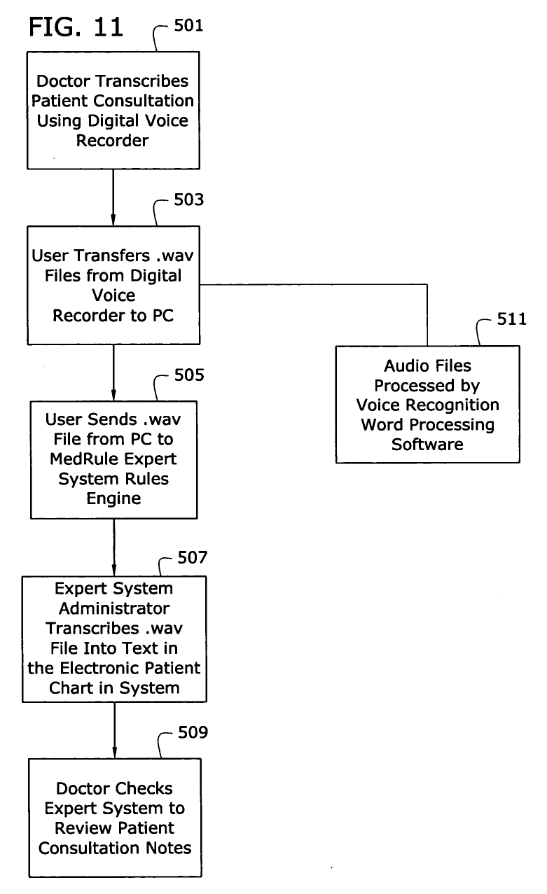

Referring to FIG. 11, in an alternate embodiment user interface includes a digital voice recorder that can upload “.wav” extension, or other suitable audio, files to a user's computer. A user, such as a doctor, transcribes 501 patient consultation using a digital voice recorder. A user transfers 503 the digital audio file(s) from digital voice recorder to a user's computer. A user electronically sends 505 audio file from computer to expert system remote central server. Expert system administrator transcribes 507 audio file into text in electronic patient chart system, and a physician or other user checks 509 expert system to review patient consultation notes. Alternately, audio files are processed 511 by voice recognition word processing software so that preliminary eligibility, referral authorization, claim check, and other procedures can automatically be undertaken by rules-engine 10.

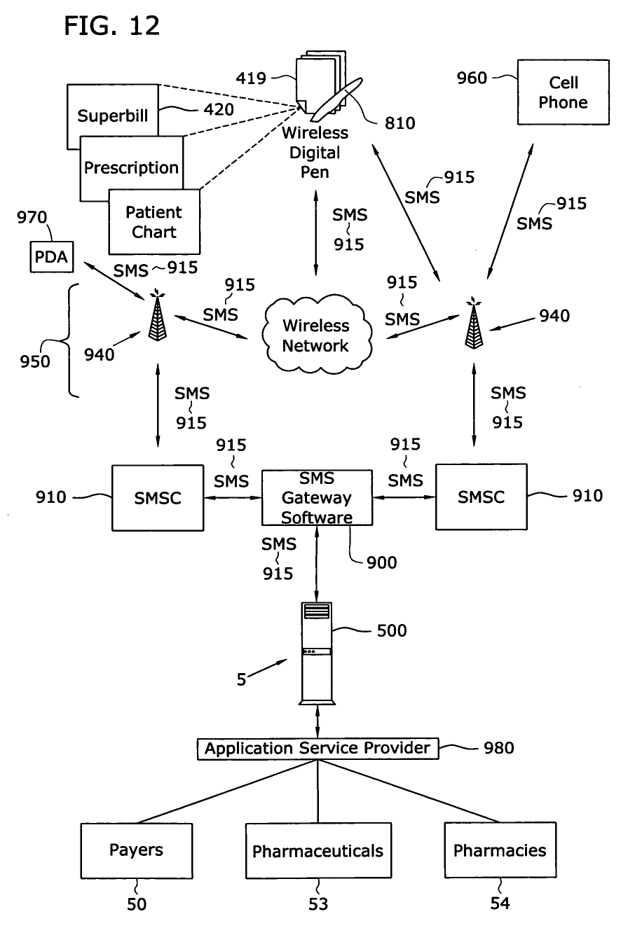

Referring to FIG. 12, in an alternate embodiment, digital pen 810 is used with paper 419 to create soft and hardcopy superbill, prescription, and patient chart form 420 that is digitally stored in pen 810, and directly sent to expert system remote central server using a wire area communications network (WAN). Using a wireless telecommunications-enabled handheld device in pen 810, data comprising form 420 is directly sent via mobile telephone frequencies using GSM mobile telecommunications technical standards, through wireless mobile network 950. Data is sent through this expert system user interface 11, which also includes short message service computers (SMSC) 910 and SMS gateway software 900, to remote central server 500. This user interface obviates the need for any personal computer connection to server 500.

Thus, in one embodiment, bidirectional short message (SMS) transmission is used to communicate directly with mobile devices, including for example, cell phone 960, digital pen 810, and PDA 970. SMS is a bidirectional service for short alphanumeric (up to 160 bytes or more) messages. Messages are transported in a store-and-forward fashion. For point-to-point SMS, a message is sent to another subscriber to the service, and an acknowledgement of receipt is provided to the sender. SMS is also used in a cell-broadcast mode, for sending text messages. Messages are also be stored in a SIM card for later retrieval.

Gateway software 900 handles the communication between expert system 5 application and SMSCs 910. SMS 915 generated by expert system 5 are sent to wireless devices by gateway software 900 via SMSCs 910. Wireless device generated SMS 915 are collected by SMSCs 910 and forwarded to expert system 5. Various data types are suitable for this embodiment of the invention. For example, text SMS are automatically translated into the appropriate 7-Bit GSM alphabet representation, or 7-Bit codings can directly be inserrted using Unicode representation. One suitable telecommunications standard is “smart messaging” offered by Nokia®, used in conjunction with Nokia enabled devices (e.g., with hardware modem and serial interface 6210, 7110, etc., and others) that use Bluetooth® specification 1.1 wireless technology.

One suitable SMS gateway is available from OpenIT, GmbH of Dusseldorf, Germany. As a result, biderectional transmission of HTTP, E-mail, Web, and scripts interfaced communications, among others, are possible—are sent and recieved using “smsd” Unix system daemons to interface gateway software 900 to SMSCs 910. The following protocols, and others, can be used to communicate with SMSCs 910: ERMES UCP (Universal Computer Protocol) including Large Account re-lated extensions, SMPP (Sort Message Peer to Peer Protocol), and OIS 0 SMS2000 Open Interface Specification. The following protocols, and others, can be provided to address SMSCs 910 over physical links as well: TCP/IP over Internet, leased lines, Dialln, X.25, X.31, TCP/IP over X.25, and frame relay.

Any user interface suitable for transmitting data making up form 420 directly over wireless telecommunications frequencies to a WAN wireless device-to-computer server gateway, however, can be used in this invention. These gateway protocols include, but are not limited to, SMS, MMS (multimedia version of SMS) WAP and WAP-push, J2ME (used in Japan), i-Mode (A compact version of HTML used by DoCoMo® and ATT® wireless), BREW (Qualcomm's® answer to J2ME, popular in Korea and China. Verizon® also supports BREW)

A wireless gateway on a telecommunication carriers' network thereby enables receipt of data to and from devices such as digital pens 410. This allows data to go to and from application servers 500, which host rules-engine 10, thereby allowing users to use the expert system wherever they are—whether it be at a hospital, a nursing home, a private home, or anywhere within the system's reach.

A second aspect of the invention is directed to a healthcare transaction system. Several of its various embodiments are substantially described above.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments that would come within the spirit and scope of the present invention.

We claim:

1. A healthcare transaction method, comprising:
providing a healthcare worker access to a remote central server through a user interface, and providing a payer connection to the server;
receiving information from the healthcare professional through the user interface; and
providing the healthcare worker automated claim assessment, claim optimization, and claim submission to the payer, based on regularly updated rules;
wherein the user interface comprises a data entry device that receives data directly from the healthcare worker, and transmits it to the remote central server.

2. The method of claim 1 wherein at least one modified treatment code and an associated reimbursement value is suggested at the user interface for selection by the healthcare worker.

3. The method of claim 1 wherein the healthcare worker is provided a real-time interconnection between the user interface and the payer.

4. The method of claim 1 wherein the user interface comprises a handheld device that receives data directly from the healthcare worker, and wirelessly transmits it directly to a wireless telecommunications network that is connected to the remote central server.

5. The method of claim 1 wherein the user interface comprises a handheld device that receives data directly from the healthcare worker, and wirelessly transmits it directly to a wireless LAN network that is connected to the remote central server.

6. The method of claim 1 wherein the user interface comprises a transceiver that receives manually-input data directly from the healthcare worker, and wirelessly transmits it directly to a wireless network that is connected to the remote central server.

7. The method of claim 6 wherein the handheld device is a pen that applies ink as it receives data.

8. The method of claim 6 wherein the handheld device is a digital recorder.

9. The method of claim 1 wherein the remote central server performs real-time, rules-based eligibility determinations.

10. The method of claim 1 wherein the remote central server performs real-time rules-based referral authorizations.

11. The method of claim 1 wherein the user interface allows integrated access to all of a patient's books of business.

12. The method of claim 1 wherein the remote central server provides rules-based healthcare worker management based on encounter data collected through the user interface.

13. The method of claim 1 wherein the remote central server provides rules-based healthcare worker monitoring based on encounter data collected through the user interface.

14. The method of claim 1 wherein the remote central server provides rules-based advertising to the user interface.

15. The method of claim 1 wherein the remote central server provides rules-based selection of a pharmacy, and sends a prescription to the pharmacy.

16. The method of claim 1 wherein the remote central server provides integrated registration, scheduling, and self-service patient check-in through an application service provider over the Internet.

17. A healthcare transaction method, comprising:
providing a healthcare worker access to a remote central server through at least one user interface, and providing at least one payer connection to the server;
receiving information from the healthcare professional directly from the at least one user interface; and
providing the healthcare professional automated claim handling and claim submission to the at least one payer, based on regularly updated rules;
wherein the at least one user interface comprises a handheld device that receives data directly from the healthcare professional, and wirelessly transmits it directly to a wireless telecommunications network that is connected to the remote central server.

18. The method of claim 17 wherein the handheld device is a pen that applies ink as it receives data.

19. The method of claim 18 wherein the pen transmits data to a telecommunications-to-server gateway that is in communication with the remote central server.

20. The method of claim 19 wherein the server is part of a rules-based application service provider expert system that integrates (1) patient scheduling and check-in; (2) automated patient eligibility checks; (3) automated rules-based, pre-adjudicated claim creation and submission; (4) automated requests for referral authorization; (5) tangible measurement of practice group financial status based on rules created based on the automatic collection of patient encounter data; and (5) creation of an additional stream of payer and third-party revenues.

21. A healthcare transaction system, comprising:
a workstation at a physician practice with access to a remote central server, and a payer with connection the server; and
at least one workstation at the physician practice automated claim assessment, claim optimization, and claim submission to the payer, based on regularly updated rules;
wherein the server receives patient information from the healthcare professional through the user interface; and
wherein the user interface comprises a data entry device that receives data directly from the healthcare worker, and transmits it to the remote central server.
